(19) United States
(12) Patent Application Publication
(10) Pub. No.: US 2024/0198383 A1
(43) Pub. Date: Jun. 20, 2024

(54) VIBRATION STRUCTURE, CONVEYANCE DEVICE, AND TACTILE SENSE PRESENTATION DEVICE

(71) Applicant: Murata Manufacturing Co., Ltd., Nagaokakyo-shi (JP)

(72) Inventor: Junichi HASHIMOTO, Nagaokakyo-shi (JP)

(21) Appl. No.: 18/594,302

(22) Filed: Mar. 4, 2024

Related U.S. Application Data
(63) Continuation of application No. PCT/JP2022/041294, filed on Nov. 7, 2022.

(30) Foreign Application Priority Data
Feb. 3, 2022 (JP) 2022-015379

(51) Int. Cl. B06B 1/06; B06B 1/02; G06F 3/01; G06F 3/044

(52) U.S. Cl. CPC B06B 1/0688; B06B 1/023; G06F 3/016; G06F 3/0448; G06F 2203/04105

(57) ABSTRACT

A vibration structure includes a fixing member; a voltage expansion/contraction member that is deformed in a first direction by a voltage; a first vibration member that is elastically coupled to the fixing member to vibrate in the first direction with respect to the fixing member; and a second vibration member that is elastically coupled to the first vibration member to vibrate in the first direction with respect to the first vibration member. The voltage expansion/contraction member is supported by the fixing member and the first vibration member or the second vibration member. A vibration of the first vibration member is superposition of a first vibration at a first resonance frequency and a second vibration at a second resonance frequency, a vibration of the second vibration member is superposition of the first vibration and the second vibration, and the second resonance frequency is a multiple of the first resonance frequency.

### CROSS REFERENCE TO RELATED APPLICATIONS

This application is a continuation of International Application No. PCT/JP2022/041294, filed Nov. 7, 2022, which claims priority to Japanese Patent Application No. 2022-15379, filed Feb. 3, 2022, the entire contents of each of which are hereby incorporated by reference in their entirety.

### TECHNICAL FIELD

The present invention relates to a vibration structure that generates vibrations, a conveyance device, and a tactile sense presentation device.

### BACKGROUND

WO 2019/013164 A (hereinafter “Patent Document 1”) discloses a conventional vibration structure that includes a film, a frame member, a vibration unit, a support unit, a first connection member, and a second connection member. The frame member has a frame shape provided with an opening as viewed in a normal direction of the frame member. The vibration unit is located in the opening as viewed in the normal direction of the frame member. The support unit couples the frame member and the vibration unit. When the support unit is elastically deformed, the vibration unit can be displaced with respect to the frame member.

Furthermore, Patent Document 1 discloses the film having a rectangular shape having a first end and a second end. The first connection member fixes the first end of the film and the vibration unit. The second connection member fixes the second end of the film and the frame member.

In the vibration structure having the structure as described above, when a voltage is applied to the film, the film is deformed so that a distance between the first end and the second end changes. As a result, the vibration unit vibrates with respect to the frame member.

Currently, there is a demand for generating new vibration in the vibration structure described in Patent Document 1.

### SUMMARY OF THE INVENTION

Accordingly, it is an object of the present invention to provide a vibration structure, a conveyance device, and a tactile sense presentation device configured to generate new vibration.

In an exemplary aspect, a vibration structure is provide that includes a fixing member; a voltage expansion/contraction member that is deformed in a first direction by application of a voltage; a first vibration member that is elastically coupled to the fixing member to vibrate in the first direction with respect to the fixing member; and a second vibration member that is elastically coupled to the first vibration member to vibrate in the first direction with respect to the first vibration member. In the exemplary aspect, the voltage expansion/contraction member is supported by the fixing member and one of the first vibration member or the second vibration member. A vibration of the first vibration member is superposition of a first vibration at a first resonance frequency and a second vibration at a second resonance frequency, a vibration of the second vibration member is superposition of the first vibration and the second vibration, and the second resonance frequency is an integral multiple of the first resonance frequency.

According to the vibration structure of the exemplary embodiments described herein, new vibration can be generated.

### BRIEF DESCRIPTION OF DRAWINGS

FIG. 1 is a perspective view of a vibration structure 20 according to a first exemplary embodiment.

FIG. 2 is an exploded perspective view of the vibration structure 20 according to the first exemplary embodiment.

FIG. 3 is a vibration model diagram of the vibration structure 20 according to the first exemplary embodiment.

FIG. 4 is a view illustrating an example of a plan view of the vibration structure 20 when a first vibration member 3 and a second vibration member 4 according to the first exemplary embodiment vibrate as viewed in an upward direction.

FIG. 5 is a view illustrating an example of a plan view of the vibration structure 20 when the first vibration member 3 and the second vibration member 4 according to the first exemplary embodiment vibrate as viewed in an upward direction.

FIG. 6 is a perspective view of a conveyance device 30 according to the first exemplary embodiment.

FIG. 7 is a diagram illustrating a drive signal DS according to the first exemplary embodiment.

FIG. 8 is a diagram illustrating a first component DS1 according to the first exemplary embodiment.

FIG. 9 is a diagram illustrating a second component DS2 according to the first exemplary embodiment.

FIG. 10 is a diagram illustrating a displacement x2 of the second vibration member 4, a velocity v2 of the second vibration member 4, an acceleration a2 of the second vibration member 4, and a velocity v40 of a substance 40 according to the drive signal DS according to the first exemplary embodiment.

FIG. 11 is a conveyance model diagram of the second vibration member 4 and the substance 40 according to the first exemplary embodiment.

FIG. 12 is a diagram illustrating a velocity v2 of the second vibration member 4 and an acceleration a2 of the second vibration member 4 according to the drive signal DS according to the first exemplary embodiment.

FIG. 13 is a perspective view of a vibration structure 20a according to a second exemplary embodiment.

FIG. 14 is an exploded perspective view of the vibration structure 20a according to the second exemplary embodiment.

FIG. 15 is a perspective view of a conveyance device 30a according to a third exemplary embodiment.

FIG. 16 is a perspective view of a tactile sense presentation device 50 according to a fourth exemplary embodiment.

### DETAILED DESCRIPTION

### First Exemplary Embodiment

(Vibration Structure)

Hereinafter, a vibration structure 20 according to a first exemplary

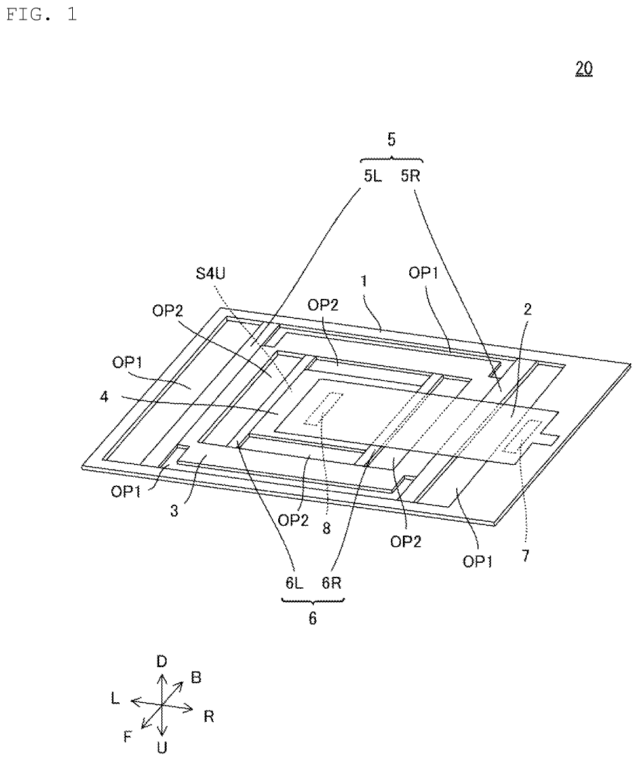

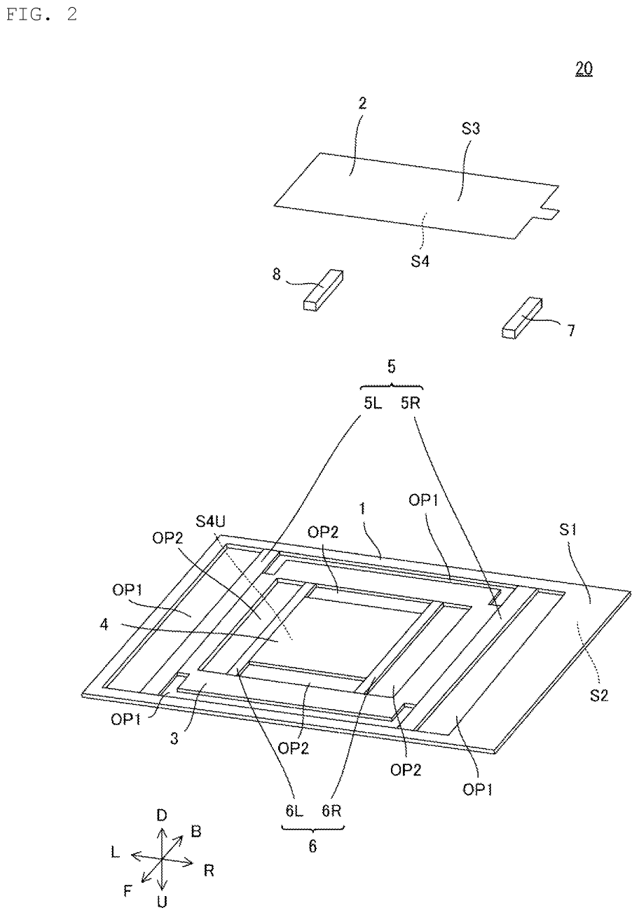

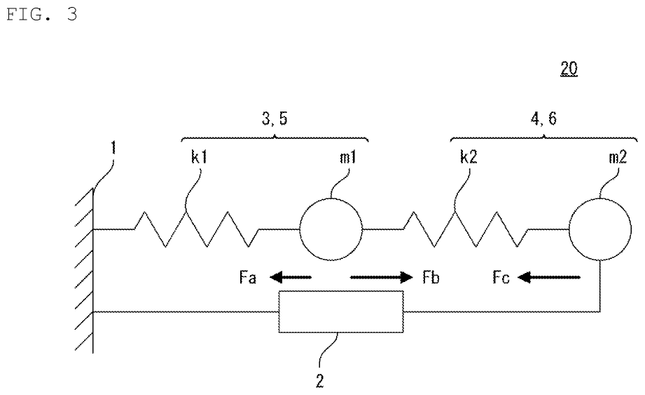

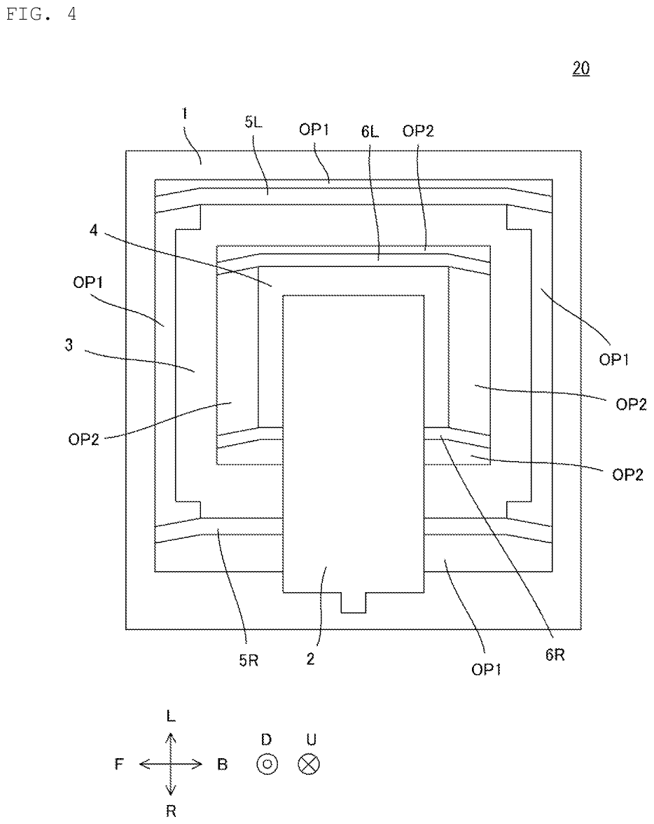

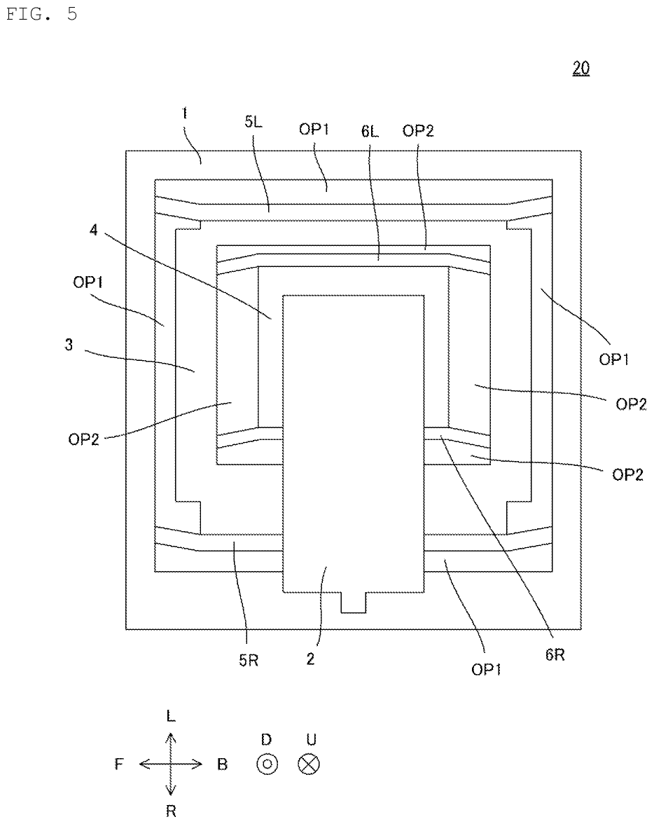

embodiment will be described with reference to the drawings. FIG. 1 is a perspective view of the vibration structure 20 according to the first embodiment. FIG. 2 is an exploded perspective view of the vibration structure 20 according to the first embodiment. FIG. 3 is a vibration model diagram of the vibration structure 20 according to the first embodiment. FIG. 4 is a view illustrating an example of a plan view of the vibration structure 20 when a first vibration member 3 and a second vibration member 4 according to the first embodiment vibrate as viewed in an upward direction. FIG. 5 is a view illustrating an example of a plan view of the vibration structure 20 when the first vibration member 3 and the second vibration member 4 according to the first embodiment vibrate as viewed in an upward direction.

According to the present specification and disclosure, directions are defined as follows. An up-down direction is a direction in which the normal to a first principal surface S1 extends. A left-right direction is a direction in which a long side of the first principal surface S1 extends. The left-right direction is orthogonal to the up-down direction. A front-rear direction is a direction in which a short side of the first principal surface S1 extends. The front-back direction is orthogonal to the up-down direction and the left-right direction. It is noted that the up-down direction, the left-right direction, and the front-rear direction in the present embodiment may not coincide with an up-down direction, a left-right direction, and a front-rear direction when the vibration structure 20 is used and that these directions are provided for purposes of describing the exemplary embodiment.

Hereinafter, X and Y are parts or members of the vibration structure 20. According to the present disclosure, each part of X is defined as follows unless otherwise specified. A front part of X refers to the front half of X. A back part of X refers to the back half of X. A left part of X refers to the left half of X. A right part of X refers to the right half of X. An upper part of X refers to the upper half of X. A lower part of X refers to the lower half of X. A front end of X refers to the end of X in the forward direction. A back end of X refers to the end of X in the backward direction. A left end of X refers to the end of X in the leftward direction. A right end of X refers to the end of X in the rightward direction. An upper end of X refers to the end of X in the upward direction. A lower end of X refers to the end of X in the downward direction. A front end portion of X refers to the front end of X and the vicinity thereof. A back end portion of X refers to the back end of X and the vicinity thereof. A left end portion of X refers to the left end of X and the vicinity thereof. A right end portion of X refers to the right end of X and the vicinity thereof. An upper end portion of X refers to the upper end of X and the vicinity thereof. A lower end portion of X refers to the lower end of X and the vicinity thereof.

Furthermore, the phrase “X is located on Y” indicates that X is located directly above Y in the exemplary aspect. Therefore, when viewed in the up-down direction, X overlaps Y. Moreover, the phrase “X is located above Y” indicates that X is located directly above Y and that X is located diagonally above Y. Therefore, when viewed in the up-down direction, X may overlap Y or may not overlap Y. This definition also applies to directions other than the upward direction.

According to the present disclosure, the phrase “X and Y are electrically connected” indicates that electricity is conducted between X and Y. Therefore, X and Y may be in contact with each other, or X and Y may not be in contact with each other. When X and Y are not in contact with each other, Z having conductivity is disposed between X and Y.

In the present embodiment, the vibration structure 20 is used as a member of a conveyance device 30 that conveys a substance 40. As an example, as illustrated in FIG. 1, the vibration structure 20 includes a fixing member 1, a voltage expansion/contraction member 2, a first vibration member 3, a second vibration member 4, a first coupling member 5, a second coupling member 6, a first connection member 7, and a second connection member 8.

As illustrated in FIG. 2, the fixing member 1 has a plate shape. More specifically, the fixing member 1 includes a first principal surface S1 and a second principal surface S2 that oppose each other. Each of the first principal surface S1 and the second principal surface S2 has a rectangular shape when viewed in the up-down direction. As illustrated in FIG. 2, each of the first principal surface S1 and the second principal surface S2 has a long side extending in the left-right direction and a short side extending in the front-rear direction. The first principal surface S1 and the second principal surface S2 are parallel to each other. Furthermore, the first principal surface S1 is located below the second principal surface S2.

As illustrated in FIG. 2, the fixing member 1 is provided with a first opening OP1. The first opening OP1 has a rectangular shape when viewed in the up-down direction. The first opening OP1 has a long side extending in the left-right direction and a short side extending in the front-rear direction. Furthermore, the first opening OP1 penetrates the fixing member 1 in the up-down direction (e.g., the thickness or vertical direction). Thus, the fixing member 1 has a rectangular frame shape. Therefore, the fixing member 1 has a left short side portion, a right short side portion, a front long side portion, and a rear short side portion.

As illustrated in FIG. 2, the first vibration member 3 is coupled to the fixing member 1 via the first coupling member 5. Furthermore, each of the first vibration member 3 and the first coupling member 5 is an elastic member. Therefore, each of the first vibration member 3 and the first coupling member 5 is elastically deformed. As a result, the first vibration member 3 is elastically coupled to the fixing member 1. The first vibration member 3 is elastically coupled to the fixing member 1 to vibrate in the left-right direction (e.g., first direction) with respect to the fixing member 1.

In the present embodiment, as illustrated in FIG. 2, the first vibration member 3 is located in the first opening OP1 when viewed in the up-down direction (e.g., normal direction of the first principal surface S1). Furthermore, as illustrated in FIG. 2, the first vibration member 3 has a plate shape. Furthermore, the first vibration member 3 has a rectangular shape when viewed in the up-down direction. Furthermore, as illustrated in FIG. 2, the first vibration member 3 has a long side extending in the left-right direction and a short side extending in the front-rear direction. A length of the long side of the first vibration member 3 is shorter than a length of the long side of the first opening OP1. As a result, as illustrated in FIG. 2, the first vibration member 3 is smaller than the first opening OP1 as viewed in the up-down direction (e.g., normal direction of the first principal surface S1).

As illustrated in FIG. 2, the first vibration member 3 is provided with a second opening OP2. The second opening OP2 has a rectangular shape when viewed in the up-down direction. The second opening OP2 has a long side extending in the left-right direction and a short side extending in the front-rear direction. Furthermore, the second opening OP2 penetrates the first vibration member 3 in the up-down direction. Thus, the first vibration member 3 has a rectangular frame shape. Therefore, the first vibration member 3 has a left short side portion, a right short side portion, a front long side portion, and a rear short side portion.

As further shown, the first coupling member 5 includes first coupling members 5R and 5L. As illustrated in FIG. 2, each of the first coupling members 5R and 5L is located in the first opening OP1 when viewed in the up-down direction. Furthermore, each of the first coupling members 5R and 5L is an elastic member that couples the first vibration member 3 and the fixing member 1.

More specifically, as illustrated in FIG. 2, the first coupling member 5R is an elastic member that couples the right short side portion of the first vibration member 3 and the front long side of the fixing member 1, and couples the right short side portion of the first vibration member 3 and the rear long side of the fixing member 1.

In the present embodiment, the first coupling member 5Rhas a plate shape as illustrated in FIG. 2. Furthermore, the first coupling member 5Rhas a rectangular shape when viewed in the up-down direction. Furthermore, as illustrated in FIG. 2, the first coupling member 5R has a long side extending in the front-rear direction and a short side extending in the left-right direction. Furthermore, the first coupling member 5R has a front end portion, a rear end portion, and an intermediate portion. The intermediate portion is a portion excluding the front end portion and the rear end portion. The intermediate portion of the first coupling member 5R is coupled to the right short side portion of the first vibration member 3. The front end of the first coupling member 5R is coupled to the front long side of the fixing member 1. The rear end of the first coupling member 5R is coupled to the rear long side of the fixing member 1. Thus, the first coupling member 5R couples the first vibration member 3 and the fixing member 1.

Furthermore, as illustrated in FIG. 2, the first coupling member 5L is an elastic member that couples the left short side portion of the first vibration member 3 and the front long side portion of the fixing member 1, and couples the left short side portion of the first vibration member 3 and the rear long side portion of the fixing member 1.

In the present embodiment, the first coupling member 5L has a plate shape as illustrated in FIG. 2. Furthermore, the first coupling member 5L has a rectangular shape when viewed in the up-down direction. As illustrated in FIG. 2, the first coupling member 5L has a long side extending in the front-rear direction and a short side extending in the left-right direction. Furthermore, the first coupling member 5L has a front end, a rear end, and an intermediate portion. The intermediate portion is a portion excluding the front end portion and the rear end portion. The intermediate portion of the first coupling member 5L is coupled to the left short side portion of the first vibration member 3. The front end of the first coupling member 5L is coupled to the front long side of the fixing member 1. The rear end of the first coupling member 5L is coupled to the rear long side of the fixing member 1. Thus, the first coupling member 5L couples the first vibration member 3 and the fixing member 1.

As illustrated in FIG. 2, the second vibration member 4 is coupled to the first vibration member 3 via the second coupling member 6. Furthermore, each of the second vibration member 4 and the second coupling member 6 is an elastic member. Therefore, each of the second vibration member 4 and the second coupling member 6 is elastically deformed. As a result, the second vibration member 4 is elastically coupled to the first vibration member 3. The second vibration member 4 is elastically coupled to the first vibration member 3 to vibrate in the left-right direction (e.g., first direction) with respect to the first vibration member 3.

In the present embodiment, as illustrated in FIG. 2, the second vibration member 4 is located in the second opening OP2 when viewed in the up-down direction (e.g., normal direction of the first principal surface S1). Furthermore, as illustrated in FIG. 2, the second vibration member 4 has a plate shape. Furthermore, the second vibration member 4 has a rectangular shape when viewed in the up-down direction. As illustrated in FIG. 2, the second vibration member 4 has a long side extending in the left-right direction and a short side extending in the front-rear direction. Therefore, the second vibration member 4 has a left short side portion, a right short side portion, a front long side portion, and a rear short side portion.

A length of the long side of the second vibration member 4 is shorter than a length of the long side of the second opening OP2. As a result, as illustrated in FIG. 2, the second vibration member 4 is smaller than the second opening OP2 as viewed in the up-down direction (e.g., normal direction of the first principal surface S1).

In the present embodiment, the second vibration member 4 includes an upper principal surface S4U. The upper principal surface S4U includes the upper end of the second vibration member 4. Furthermore, the normal direction of the upper principal surface S4U is the up-down direction.

The second coupling member 6 includes second coupling members 6R and 6L. As illustrated in FIG. 2, each of the second coupling members 6R and 6L is located in the second opening OP2 when viewed in the up-down direction. Furthermore, each of the second coupling members 6R and 6L is an elastic member that couples the second vibration member 4 and the first vibration member 3.

More specifically, as illustrated in FIG. 2, the second coupling member 6R is an elastic member that couples the right short side portion of the second vibration member 4 and the front long side portion of the first vibration member 3, and couples the right short side portion of the second vibration member 4 and the rear long side portion of the first vibration member 3.

In the present embodiment, the second coupling member 6R has a plate shape as illustrated in FIG. 2. Furthermore, the second coupling member 6R has a rectangular shape when viewed in the up-down direction. Furthermore, as illustrated in FIG. 2, the second coupling member 6R has a long side extending in the front-rear direction and a short side extending in the left-right direction. The second coupling member 6R has a front end portion, a rear end portion, and an intermediate portion. The intermediate portion is a portion excluding the front end portion and the rear end portion. The intermediate portion of the second coupling member 6R is coupled to the right short side portion of the second vibration member 4. The front end of the second coupling member 6R is coupled to the front long side of the first vibration member 3. The rear end of the second coupling member 6R is coupled to the rear long side of the first vibration member 3. Thus, the second coupling member 6R couples the second vibration member 4 and the first vibration member 3.

As further shown, the second coupling member 6L is an elastic member that couples the left short side portion of the second vibration member 4 and the front long side portion of the first vibration member 3, and couples the left short side portion of the second vibration member 4 and the rear long side portion of the first vibration member 3.

In the present embodiment, the second coupling member 6L has a plate shape as illustrated in FIG. 2. Furthermore, the second coupling member 6L has a rectangular shape when viewed in the up-down direction. Furthermore, as illustrated in FIG. 2, the second coupling member 6L has a long side extending in the front-rear direction and a short side extending in the left-right direction. Furthermore, the second coupling member 6L has a front end portion, a rear end portion, and an intermediate portion. The intermediate portion is a portion excluding the front end portion and the rear end portion. The intermediate portion of the second coupling member 6L is coupled to the left short side portion of the second vibration member 4. The front end of the second coupling member 6L is coupled to the front long side of the first vibration member 3. The rear end of the second coupling member 6L is coupled to the rear long side of the first vibration member 3. Thus, the second coupling member 6L couples the second vibration member 4 and the first vibration member 3.

In the present embodiment, the fixing member 1, the first vibration member 3, the second vibration member 4, the first coupling member 5, and the second coupling member 6 are made of the same material. According to exemplar aspects, the materials of the fixing member 1, the first vibration member 3, the second vibration member 4, the first coupling member 5, and the second coupling member 6 are, for example, acrylic resin, polyethylene terephthalate (PET), polycarbonate (PC), fiber-reinforced plastic (FRP), metal, glass, a PCB substrate, or a silicon substrate. That is, the fixing member 1, the first vibration member 3, the second vibration member 4, the first coupling member 5, and the second coupling member 6 are one plate-shaped member. More specifically, the fixing member 1, the first vibration member 3, the second vibration member 4, the first coupling member 5, and the second coupling member 6 are manufactured by punching one plate-shaped member.

The voltage expansion/contraction member 2 is a member that is configured to expand and contract when a voltage is applied to the voltage expansion/contraction member 2. In the present embodiment, the voltage expansion/contraction member 2 has a thin plate shape as illustrated in FIG. 1. The voltage expansion/contraction member 2 includes a piezoelectric body, a first electrode, and a second electrode. The piezoelectric body has an upper principal surface and a lower principal surface. The first electrode is provided on an upper principal surface of the piezoelectric body (not illustrated). The first electrode covers the upper principal surface of the piezoelectric body.

The second electrode is provided on the lower principal surface of the piezoelectric body (not illustrated). The second electrode covers the lower principal surface of the piezoelectric body.

The voltage expansion/contraction member 2 includes a third principal surface S3 and a fourth principal surface S4 that oppose each other. The third principal surface S3 is the lower principal surface of the second electrode. The fourth principal surface S4 is the upper principal surface of the first electrode. Each of the third principal surface S3 and the fourth principal surface S4 has a rectangular shape when viewed in the up-down direction. As illustrated in FIG. 2, each of the third principal surface S3 and the fourth principal surface S4 has a long side extending in the left-right direction and a short side extending in the front-rear direction. The third principal surface S3 and the fourth principal surface S4 are parallel to each other. Furthermore, the third principal surface S3 is located below the fourth principal surface S4. The piezoelectric body expands and contracts in the left-right direction when a voltage is applied to the first electrode and the second electrode.

In the present embodiment, the voltage expansion/contraction member 2 includes a piezoelectric body having a lead-free piezoelectric ceramic. The lead-free piezoelectric ceramic is, for example, a niobium-based piezoelectric ceramic. The niobium-based piezoelectric ceramic is, for example, an alkali niobate piezoelectric ceramic.

The voltage expansion/contraction member 2 is configured to be deformed in the left-right direction (e.g., first direction) by application of a voltage. In the present embodiment, the voltage expansion/contraction member 2 expands in the left-right direction when a positive voltage is applied to the voltage expansion/contraction member 2. On the other hand, the voltage expansion/contraction member 2 contracts in the left-right direction when a negative voltage is applied to the voltage expansion/contraction member 2. That is, the displacement of the voltage expansion/contraction member 2 is proportional to the voltage applied to the voltage expansion/contraction member 2. As a result, the voltage expansion/contraction member 2 vibrates in the left-right direction, for example, when an AC voltage is applied to the voltage expansion/contraction member 2. It is noted that the AC voltage is a voltage at which positive and negative of the voltage periodically change.

The voltage expansion/contraction member 2 is supported by the fixing member 1 according to the exemplary aspect. More specifically, as shown in FIG. 2, the right end portion of the voltage expansion/contraction member 2 is supported by the first principal surface S1 of the right short side portion of the fixing member 1 via the first connection member 7.

The first connection member 7 supports the voltage expansion/contraction member 2 on the fixing member 1. More specifically, as shown in FIG. 2, the first connection member 7 has a thickness in the up-down direction. In an exemplary aspect, the material of the first connection member 7 is, for example, metal, PET, PC, polyimide, or ABS resin. The first connection member 7 supports the voltage expansion/contraction member 2 on the fixing member 1 via, for example, an adhesive (not illustrated). In this case, the adhesive is a part of the first connection member 7. It is also noted that the first connection member 7 may be an adhesive.

In the present embodiment, the voltage expansion/contraction member 2 is supported by the second vibration member 4. More specifically, as illustrated in FIG. 1, the left end portion of the voltage expansion/contraction member 2 is supported on the first principal surface S1 of the second vibration member 4 via the second connection member 8. That is, the voltage expansion/contraction member 2 is supported by the fixing member 1 and the second vibration member 4. It is noted that, in the present embodiment, the voltage expansion/contraction member 2 is not in contact with the first vibration member 3.

The second connection member 8 supports the voltage expansion/contraction member 2 on the second vibration member 4. More specifically, as shown in FIG. 2, the second connection member 8 has a thickness in the up-down direction. The material of the second connection member 8 is, for example, metal, PET, PC, polyimide, or ABS resin. The second connection member 8 supports the voltage expansion/contraction member 2 on the second vibration member 4 via, for example, an adhesive (not illustrated). In this case, the adhesive is a part of the second connection member 8. It is noted that the second connection member 8 may be an adhesive.

In the present embodiment, the voltage expansion/contraction member 2 is stretched between the first connection member 7 and the second connection member 8 so that the first connection member 7 is pulled in the left direction by the voltage expansion/contraction member 2 and the second connection member 8 is pulled in the right direction by the voltage expansion/contraction member 2 in a state of being supported by the fixing member 1 and the second vibration member 4. As a result, while the voltage expansion/contraction member 2 is supported by the fixing member 1 and the second vibration member 4, tension that contracts in the left-right direction is generated in the voltage expansion/contraction member 2. Furthermore, in the present embodiment, each of the first connection member 7 and the second connection member 8 has a thickness in the up-down direction. Therefore, the voltage expansion/contraction member 2 is not in contact with the first vibration member 3 while being supported by the fixing member 1 and the second vibration member 4.

According to the exemplary aspect, the voltage expansion/contraction member 2 is configured to be deformed in the left-right direction by application of a voltage. At this time, the first vibration member 3 is elastically coupled to the fixing member 1 to vibrate in the left-right direction with respect to the fixing member 1. Furthermore, the second vibration member 4 is elastically coupled to the first vibration member 3, thereby vibrating in the left-right direction with respect to the first vibration member 3. At this time, the vibration of the first vibration member 3 and the vibration of the second vibration member 4 are a two-degree-of-freedom vibration system as illustrated in FIG. 3. Here, the sum of the mass of the first vibration member 3 and the mass of the first coupling member 5 is referred to as a first mass m1, the combined value of the elastic coefficient of the first vibration member 3 and the elastic coefficient of the first coupling member 5 is referred to as a first elastic coefficient k1, the sum of the mass of the second vibration member 4 and the mass of the second coupling member 6 is referred to as a second mass m2, and the combined value of the elastic coefficient of the second vibration member 4 and the elastic coefficient of the second coupling member 6 is referred to as a second elastic coefficient k2. Therefore, the first mass ml, the first elastic coefficient k1, the second mass m2, and the second elastic coefficient k2 are positive values.

Here, the displacement of the first vibration member 3 when the first vibration member 3 and the second vibration member 4 are not vibrating is set to 0, and the displacement of the first vibration member 3 when the first vibration member 3 and the second vibration member 4 are vibrating is set to x1. Furthermore, as an example, the displacement of the second vibration member 4 when the first vibration member 3 and the second vibration member 4 are not vibrating is set to 0, and displacement of the second vibration member 4 when the first vibration member 3 and the second vibration member 4 are vibrating is set to x2. It is noted that, in FIG. 3, the displacement x1 of the first vibration member 3, the displacement x2 of the second vibration member 4, and forces Fa, Fb, and Fc are positive in the right direction and negative in the left direction.

The equation of motion of the first vibration member 3 in the left-right direction is expressed by the following Formula 1.

$$[ Mathematical Formula 1 ] :$$

$$m 1 \cdot a 1 = - Fa + Fb = - k 1 \cdot x 1 + k 2 \cdot ( x 2 - x 1 ) \qquad Formula 1$$

The equation of motion of the second vibration member 4 in the left-right direction is expressed by the following Formula 2.

$$[ Mathematical Formula 2 ] :$$

$$m 2 \cdot a 2 = - Fc = - k 2 \cdot ( x 2 - x 1 ) \qquad Formula 2$$

By solving Formula 1 and Formula 2, the displacement x1 of the first vibration member 3 is expressed by the following Formula 3.

$$[ Mathematical Formula 3 ] :$$

$$x 1 - A \cdot sin ( 2 π f 1 \cdot t + φ 1 ) + B \cdot sin ( 2 π f 2 \cdot t + φ 2 ) \qquad Formula 3$$

Here, A and B are constants that are not 0, respectively. Furthermore, t is a time. The first term on the right side of Formula 3 is a first vibration. The second term on the right side of Formula 3 is a second vibration. Furthermore, f1 and f2 are positive values and different values from each other. f1 is a first resonance frequency of the first vibration. That is, f1 is the natural frequency of the first vibration. f2 is a second resonance frequency of the second vibration. That is, f2 is the natural frequency of the second vibration. Here, the first resonance frequency f1 is smaller than the second resonance frequency f2. Furthermore, the second resonance frequency f2 is an integral multiple of the first resonance frequency f1. In the present embodiment, as an example, the second resonance frequency f2 is twice the first resonance frequency f1. That is, the second resonance frequency f2 is an even multiple of the first resonance frequency f1. φ1 is an initial phase of the first vibration. φ2 is an initial phase of the second vibration. Therefore, the vibration of the first vibration member 3 is the superposition of the first vibration at the first resonance frequency f1 and the second vibration at the second resonance frequency f2 as shown in Formula 3.

Furthermore, by solving Formula 1 and Formula 2, the displacement x2 of the second vibration member 4 is expressed by the following Formula 4.

$$[ Mathematical Formula 4 ] :$$

$$x 2 = C \cdot sin ( 2 π f 1 \cdot t + φ 1 ) + D \cdot sin ( 2 π f 2 \cdot t + φ 2 ) \qquad Formula 4$$

Here, C and D are constants that are not 0, respectively. The first term on the right side of Formula 4 is a first vibration. The second term on the right side of Formula 4 is a second vibration. That is, the vibration of the second vibration member 4 is the superposition of the first vibration at the first resonance frequency f1 and the second vibration at the second resonance frequency f2 as shown in Formula 4.

The vibration of the first vibration member 3 and the vibration of the second vibration member 4 form a coupled vibration as shown in Formula 3 and Formula 4. That is, the vibration of the first vibration member 3 and the vibration of the second vibration member 4 act on each other. Furthermore, the first vibration and the second vibration are standard vibrations of coupled vibrations. Here, the first vibration is a first mode, and the second vibration is a second mode.

In the first mode, both the first vibration member 3 and the second vibration member 4 vibrate in the same direction in the left-right direction as illustrated in FIG. 4.

That is, the first mode is an in-phase mode. It is noted that, in the present embodiment, in the first mode, the first coupling members 5R and 5L and the second coupling members 6R and 6L vibrate in the same direction as the vibration direction of the first vibration member 3 and the second vibration member 4 as illustrated in FIG. 4.

In the second mode, the first vibration member 3 and the second vibration member 4 vibrate in different directions in the left-right direction as illustrated in FIG. 5. That is, the second mode is an antiphase mode. It is noted that, in the present embodiment, in the second mode, the first coupling members 5R and 5L vibrate in the same direction as the vibration direction of the first vibration member 3 as illustrated in FIG. 5. Furthermore, in the second mode, the second coupling members 6R and 6L vibrate in the same direction as the vibration direction of the second vibration member 4.

(Conveyance Device)

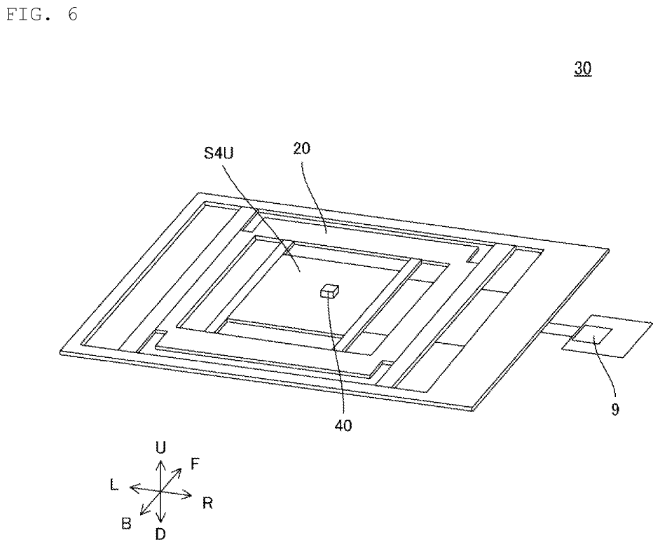

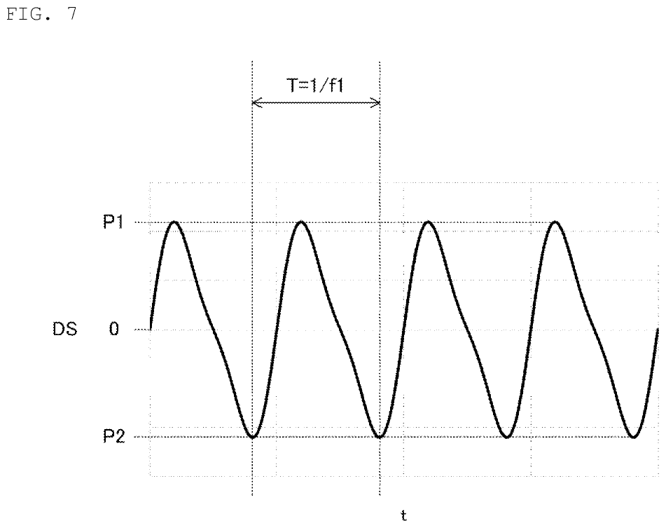

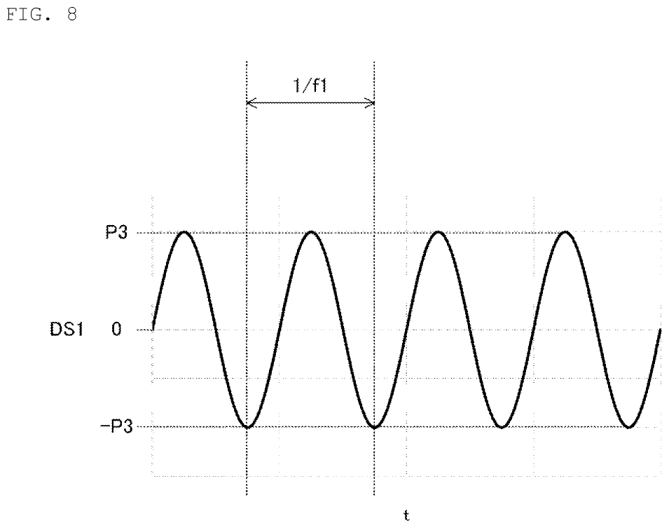

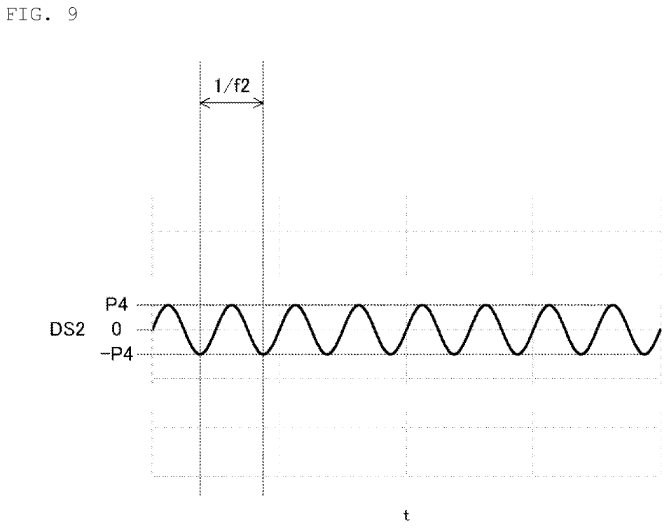

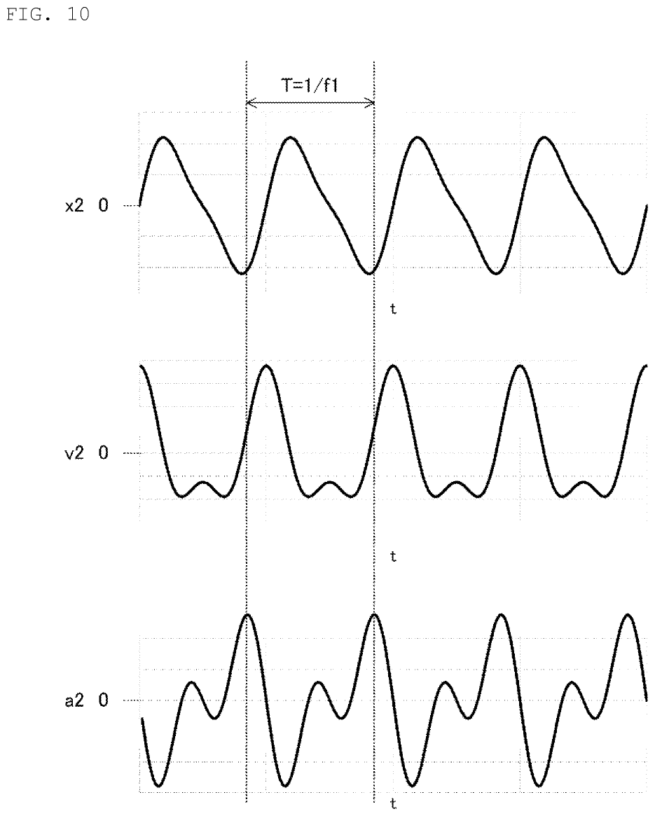

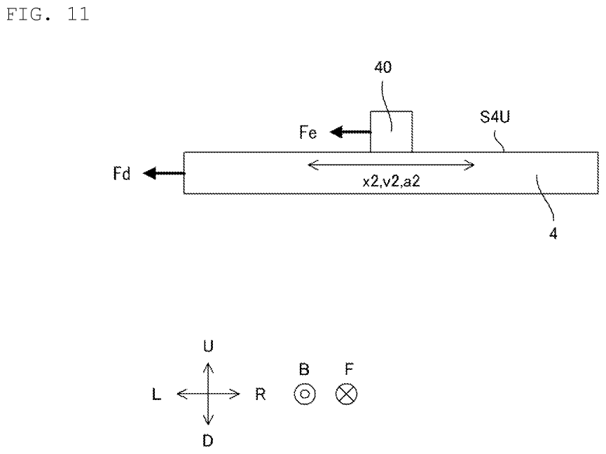

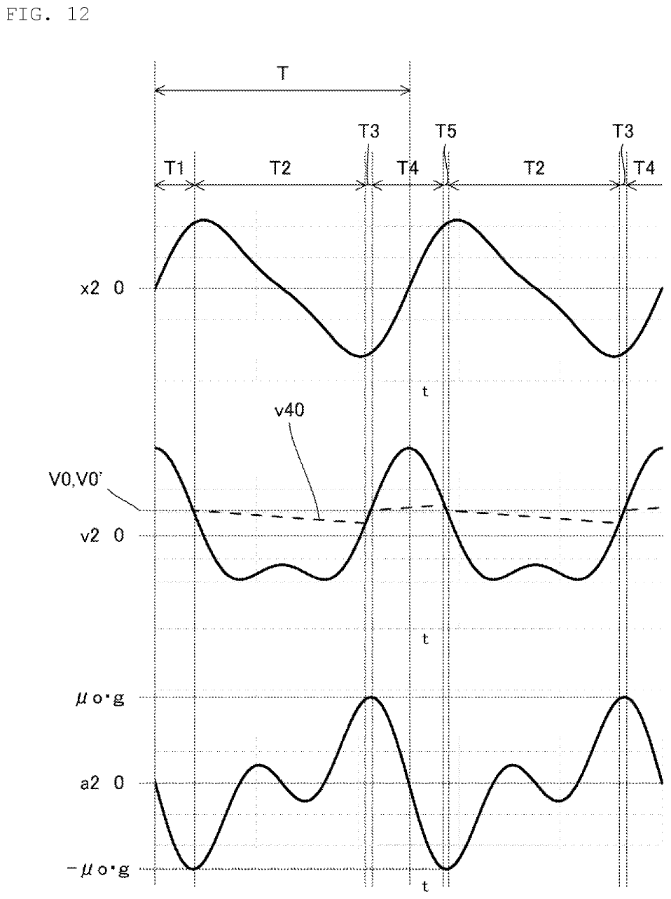

Hereinafter, the conveyance device 30 including the vibration structure 20 will be described with reference to the drawings according to an exemplary aspect. FIG. 6 is a perspective view of the conveyance device 30 according to the first embodiment. FIG. 7 is a diagram illustrating a drive signal DS according to the first embodiment. FIG. 8 is a diagram illustrating a first component DS1 according to the first embodiment. FIG. 9 is a diagram illustrating a second component DS2 according to the first embodiment. FIG. 10 is a diagram illustrating a displacement x2 of the second vibration member 4, a velocity v2 of the second vibration member 4, an acceleration a2 of the second vibration member 4, and a velocity v40 of the substance 40 according to the drive signal DS according to the first embodiment. FIG. 11 is a conveyance model diagram of the second vibration member 4 and the substance 40 according to the first embodiment. FIG. 12 is a diagram illustrating the velocity v2 of the second vibration member 4 and the acceleration a2 of the second vibration member 4 according to the drive signal DS according to the first embodiment. In FIG. 7, the horizontal axis represents the value at time t, and the vertical axis represents the voltage value of the drive signal DS. In FIG. 8, the horizontal axis represents the value at time t, and the vertical axis represents the voltage value of the first component DS1. In FIG. 9, the horizontal axis represents the value at time t, and the vertical axis represents the voltage value of the second component DS2. In FIG. 10, the horizontal axis represents the value at time t, and the vertical axis represents the value of displacement x2 of the second vibration member 4, the value of velocity v2 of the second vibration member 4, the value of velocity v40 of the substance 40, and the value of acceleration a2 of the second vibration member 4. In FIG. 12, the horizontal axis represents the value at time t, and the vertical axis represents the value of the velocity v2 of the second vibration member 4 and the value of the acceleration a2 of the second vibration member 4. It is noted that, in FIG. 10, the velocity v40 of the substance 40 is indicated by a dotted line.

In operation, the conveyance device 30 is used to convey the substance 40 disposed on the upper principal surface S4U of the second vibration member 4. In the present embodiment, as an example, the substance 40 is a small component. As an example, as illustrated in FIG. 6, the conveyance device 30 includes the vibration structure 20 and a drive circuit 9. The drive circuit 9 applies a drive signal DS to the voltage expansion/contraction member 2. More specifically, the drive circuit 9 applies a voltage of the drive signal DS between the first electrode and the second electrode to vibrate the voltage expansion/contraction member 2. That is, as illustrated in FIG. 7, the drive signal DS has a maximum value P1 and a minimum value P2. The maximum value P1 is larger than 0. Furthermore, the minimum value P2 is smaller than 0. As a result, the voltage expansion/contraction member 2 vibrates in the left-right direction. It is noted that, in the present embodiment, the upper principal surface S4U of the second vibration member 4 is horizontal.

In the present embodiment, the drive signal DS is a combination of the first component DS1 of the first resonance frequency f1 and the second component DS2 of the second resonance frequency f2. Specifically, DS=DS1+DS2. As illustrated in FIG. 8, the first component DS1 is a sine wave. It is noted that, in the present embodiment, the initial phase of the first component DS1 is 0. Furthermore, as illustrated in FIG. 9, the second component DS2 is a sine wave. It is noted that, in the present embodiment, the initial phase of the second component DS2 is 0. Furthermore, the amplitude P3 of the first component DSI is larger than the amplitude P4 of the second component DS2. As a result, in the present embodiment, as illustrated in FIG. 7, the drive signal DS is an AC signal having a periodic waveform with a cycle T as one cycle. It is noted that the frequency f of the drive signal DS is the reciprocal of the cycle T.

The second resonance frequency f2 is an integral multiple of the first resonance frequency f1. As a result, the frequency f of the drive signal DS is the first resonance frequency f1. Therefore, as illustrated in FIG. 7, the cycle T of the drive signal DS is a reciprocal of the first resonance frequency f1.

When the drive signal DS is applied to the voltage expansion/contraction member 2, the displacement x1 of the first vibration member 3 depends on the superposition of the first component DS1 and the second component DS2. Furthermore, when the drive signal DS is applied to the voltage expansion/contraction member 2, the displacement x2 of the second vibration member 4 depends on the superposition of the first component DS1 and the second component DS2. As an example, as illustrated in FIG. 10, the displacement x2 of the second vibration member 4 is proportional to the voltage of the drive signal DS. As a result, when the drive signal DS is applied to the voltage expansion/contraction member 2, the displacement x2 of the second vibration member 4 is expressed by the following Formula 5.

$$[ Mathematical Formula 5 ] :$$

$$x 2 = A 1 \cdot sin ( 2 π f 1 \cdot t ) + A 2 \cdot sin ( 2 π f 2 \cdot t ) \qquad Formula 5$$

Here, A1 and A2 are constants that are not 0, respectively. Therefore, the velocity v2 of the second vibration member 4 is expressed by the following Formula 6. Furthermore, the acceleration a2 of the second vibration member 4 is expressed by the following Formula 7.

$$[ Mathematical Formula 6 ] :$$

$$v 2 = A 1 \cdot 2 π f 1 \cdot cos ( 2 π f 1 \cdot t ) + A 2 \cdot 2 π f 2 \cdot cos ( 2 π f 2 \cdot t ) \qquad Formula 6$$

$$[ Mathematical Formula 7 ] :$$

$$a 2 = - A 1 \cdot {( 2 π f 1 )}^{2} \cdot sin ( 2 π f 1 \cdot t ) - A 2 \cdot {( 2 π f 2 )}^{2} \cdot sin ( 2 π f 2 \cdot t ) \qquad Formula 7$$

As a result, the velocity v2 of the second vibration member 4 has a periodic waveform with the cycle T as one cycle as illustrated in FIG. 10. Furthermore, as illustrated in FIG. 10, the acceleration a2 of the second vibration member 4 has a periodic waveform with the cycle T as one cycle. It is noted that, as illustrated in FIG. 10, the cycle T is a reciprocal of first resonance frequency f1.

Here, the mass of the substance 40 is m40, and the mass of the second vibration member 4 is m4. As illustrated in FIG. 11, the second vibration member 4 vibrates in the left-right direction.

As illustrated in FIGS. 6 and 11, the substance 40 and the upper principal surface S4U of the second vibration member 4 are in contact with each other. That is, when a force Fd in the left-right direction acting on the second vibration member 4 is small, the substance 40 and the second vibration member 4 move integrally. At this time, a force Fe in the left-right direction acting on the substance 40 is a frictional force that the substance 40 receives from the second vibration member 4. Specifically, when the substance 40 stands still on the upper principal surface S4U of the second vibration member 4 and the following Formula 8 is satisfied, the substance 40 and the second vibration member 4 move integrally.

$$[ Mathematical Formula 8 ] :$$

$$\vert a 2 \vert \leq μ o \cdot g \qquad Formula 8$$

Here, μo is a static friction coefficient between the substance 40 and the upper principal surface S4U of the second vibration member 4. g is the magnitude of the gravitational acceleration. That is, when the absolute value of the acceleration a2 of the second vibration member 4 becomes larger than the product of the static friction coefficient po and the magnitude g of the gravitational acceleration, the substance 40 starts to move on the upper principal surface S4U of the second vibration member 4. It is noted that, in FIG. 12, the displacement x2 of the second vibration member 4, the velocity v2 of the second vibration member 4, and the acceleration a2 of the second vibration member 4 are positive in the left direction and negative in the right direction.

The movement of the substance 40 will be described with reference to FIG. 12. When the velocity v2 of the second vibration member 4 is positive and the absolute value of the acceleration a2 of the second vibration member 4 is less than or equal to the product of the static friction coefficient po and the magnitude g of the gravitational acceleration, the substance 40 and the second vibration member 4 move integrally (e.g., a period of T1 in FIG. 12).

When the absolute value of the acceleration a2 of the second vibration member 4 becomes larger than the product of the static friction coefficient μo and the magnitude g of the gravitational acceleration (e.g., the end time of the period of T1 in FIG. 12), the substance 40 starts to move in the left direction with respect to the second vibration member 4 (e.g., a period of T2 in FIG. 12). More specifically, when the absolute value of the acceleration a2 of the second vibration member 4 becomes larger than the product of the static friction coefficient po and the magnitude g of the gravitational acceleration, the second vibration member 4 tends to move in the right direction with respect to the substance 40. During the period T2, the force that the second vibration member 4 receives from the substance 40 is a dynamic friction force. A direction of the dynamic friction force that the second vibration member 4 receives from the substance 40 is the left direction. As a result, the direction of the dynamic friction force that the substance 40 receives from the second vibration member 4 is the right direction. Therefore, in the period T2, the direction of the force Fe acting on the substance 40 is the right direction. Furthermore, the magnitude of the acceleration a40 of the substance 40 is equal to the product of the coefficient of dynamic friction μ between the substance 40 and the upper principal surface S4U of the second vibration member 4 and the magnitude g of the gravitational acceleration. As a result, the velocity v40 of the substance 40 in the period T2 is expressed by the following Formula 9.

$$[ Mathematical Formula 9 ] :$$

$$v 40 = v 0 - μ \cdot g \cdot ( t - T 1 ) \qquad Formula 9$$

Here, the velocity v0 is the velocity of the second vibration member 4 and the substance 40 at the end time of the period T1. Since the direction of the dynamic friction force received by the substance 40 from the second vibration member 4 is the right direction, the second term on the right side of Formula 9 is negative. The first term on the right side of Formula 9 is expressed by the following Formula 10.

$$[ Mathematical Formula 10 ] :$$

$$v 0 = A 1 \cdot 2 π f 1 \cdot cos ( 2 π f 1 \cdot T 1 ) + A 2 \cdot 2 π f 2 \cdot cos ( 2 π f 2 \cdot T 1 ) \qquad Formula 10$$

A moving distance Ll in the left direction of the substance 40 in the period

T2 is expressed by the following Formula 11.

$$[ Mathematical Formula 11 ] :$$

$$L 1 = v 0 \cdot T 2 - \frac{1}{2} μ \cdot g \cdot T {2}^{2} \qquad Formula 11$$

When the velocity v2 of the second vibration member 4 becomes equal to the velocity v40 of the substance 40 (the end time of the period T2 in FIG. 12), the substance 40 and the second vibration member 4 start to move integrally (a period T3 in FIG. 12). More specifically, when the velocity v2 of the second vibration member 4 becomes equal to the velocity v40 of the substance 40, the absolute value of the acceleration a2 of the second vibration member 4 is smaller than the product of the static friction coefficient po and the magnitude g of the gravitational acceleration. As a result, the substance 40 stands still on the upper principal surface S4U of the second vibration member 4. That is, in the period T3, the substance 40 and the second vibration member 4 move integrally.

When the absolute value of the acceleration a2 of the second vibration member 4 becomes larger than the product of the static friction coefficient μo and the magnitude g of the gravitational acceleration (e.g., the end time of the period of T3 in FIG. 12), the substance 40 starts to move rightward with respect to the second vibration member 4 (e.g., a period of T4 in FIG. 12). More specifically, when the absolute value of the acceleration a2 of the second vibration member 4 becomes larger than the product of the static friction coefficient po and the magnitude g of the gravitational acceleration, the second vibration member 4 tends to move in the left direction with respect to the substance 40. During the period T4, the force that the second vibration member 4 receives from the substance 40 is a dynamic friction force. The direction of the dynamic friction force received by the second vibration member 4 from the substance 40 is the right direction. As a result, the direction of the dynamic friction force that the substance 40 receives from the second vibration member 4 is the left direction. Therefore, in the period T4, the direction of the force Fe acting on the substance 40 is the left direction. Furthermore, the magnitude of the acceleration a40 of the substance 40 is equal to the product of the coefficient of dynamic friction μ between the substance 40 and the upper principal surface S4U of the second vibration member 4 and the magnitude g of the gravitational acceleration. As a result, the velocity v40 of the substance 40 in the period T4 is expressed by the following Formulas 12 and 13.

$$[ Mathematical Formula 12 ] :$$

$$v 40 = v 10 + μ \cdot g \cdot ( t - T 10 ) \qquad Formula 12$$

Here, the velocity v10 is the velocity of the second vibration member 4 and the substance 40 at the end time of the period T3. Since the direction of the dynamic friction force received by the substance 40 from the second vibration member 4 is the left direction in the period T4, the second term on the right side of Formula 12 is positive. The first term on the right side of Formula 12 is expressed by the following Formula 14.

$$[ Mathematical Formula 14 ] :$$

$$v 10 = A 1 \cdot 2 π f 1 \cdot cos ( 2 π f 1 \cdot T 10 ) + A 2 \cdot 2 π f 2 \cdot cos ( 2 π f 2 \cdot T 10 ) \qquad Formula 14$$

A moving distance L2 in the left direction of the substance 40 in the period T4 is expressed by the following Formula 15.

$$[ Mathematical Formula 15 ] :$$

$$L 2 = v 0 \cdot T 4 + \frac{1}{2} μ \cdot g \cdot T {4}^{2} \qquad Formula 15$$

When the velocity v2 of the second vibration member 4 equal to the velocity v40 of the substance 40 (e.g., the end time of the period T4 in FIG. 12), the substance 40 and the second vibration member 4 start to move integrally (a period T5 in FIG. 12). More specifically, when the velocity v2 of the second vibration member 4 becomes equal to the velocity v40 of the substance 40, the absolute value of the acceleration a2 of the second vibration member 4 is smaller than the product of the static friction coefficient μo and the magnitude g of the gravitational acceleration. As a result, the substance 40 stands still on the upper principal surface S4U of the second vibration member 4. That is, in the period T5, the substance 40 and the second vibration member 4 move integrally.

After the end time of T5, the substance 40 repeats the motion from the period T2 to the period T5 described above. That is, the substance 40 continues to move in the left direction intermittently with respect to the second vibration member 4. As a result, the substance 40 is conveyed in the left direction.

### Technical Advantages

According to the vibration structure 20, new vibration can be generated. More specifically, the voltage expansion/contraction member 2 is deformed in the left-right direction (e.g., first direction) by application of a voltage. Accordingly, the first vibration member 3 vibrates in the left-right direction (e.g., first direction) with respect to the fixing member 1. Furthermore, the second vibration member 4 vibrates in the left-right direction (e.g., first direction) with respect to the first vibration member 3.

Since the vibration of the first vibration member 3 and the vibration of the second vibration member 4 act on each other, each of the vibration of the first vibration member 3 and the vibration of the second vibration member 4 is a superposition of the first vibration of the first resonance frequency f1 and the second vibration of the second resonance frequency f2 as shown in each of Formulas 3 and 4. The first resonance frequency f1 is a natural frequency of the first vibration. The second resonance frequency f2 is a natural frequency of the second vibration. As a result, when vibration of the first resonance frequency f1 is applied from the voltage expansion/contraction member 2 to the second vibration member 4, the first vibration of the first resonance frequency f1 is amplified in the second vibration member 4 due to resonance between the second vibration member 4 and the voltage expansion/contraction member 2. Furthermore, when vibration of the second resonance frequency f2 is applied from the voltage expansion/contraction member 2 to the second vibration member 4, the second vibration of the second resonance frequency f2 is amplified in the second vibration member 4 due to resonance between the second vibration member 4 and the voltage expansion/contraction member 2. Therefore, according to the vibration structure 20, as an example, as illustrated in FIG. 10, the waveform of the displacement x2 of the second vibration member 4 can be formed in a sawtooth wave shape. As a result, according to the vibration structure 20, new vibration can be generated.

Furthermore, according to the vibration structure 20, by using the vibration structure 20 as a member of the conveyance device 30, the substance 40 can be conveyed with a low applied voltage. More specifically, when vibration of the first resonance frequency f1 is applied from the voltage expansion/contraction member 2 to the second vibration member 4, the first vibration of the first resonance frequency f1 is amplified in the second vibration member 4. Furthermore, when vibration of the second resonance frequency f2 is applied from the voltage expansion/contraction member 2 to the second vibration member 4, the second vibration of the second resonance frequency f2 is amplified in the second vibration member 4. That is, despite the voltage applied to the voltage expansion/contraction member 2 being low, the first vibration at the first resonance frequency f1 and the second vibration at the second resonance frequency f2 can be increased in the second vibration member 4.

Furthermore, the second resonance frequency f2 is an integral multiple of the first resonance frequency f1. Therefore, the frequency of the displacement x2 of the second vibration member 4 becomes the first resonance frequency f1 as illustrated in FIG. 10. As a result, the displacement x2 of the second vibration member 4 periodically changes in the cycle T, which is a reciprocal of the first resonance frequency f1. Therefore, despite an applied voltage being low, in the first vibration member 3 and the second vibration member 4, the first vibration at the first resonance frequency f1 and the second vibration at the second resonance frequency f2 can be increased, and each of the displacement x1 of the first vibration member 3 and the displacement x2 of the second vibration member 4 periodically changes. As a result, according to the vibration structure 20, the substance 40 can be conveyed with a low applied voltage by using the vibration structure 20 as a member of the conveyance device 30.

According to the vibration structure 20, the substance 40 can be stably conveyed in the same direction by using the vibration structure 20 as a member of the conveyance device 30. More specifically, the second resonance frequency f2 is an even multiple of the first resonance frequency f1. As a result, as shown in FIG. 12, the positive and negative of the velocity v2 of the second vibration member 4 at the time when the absolute value of the acceleration a2 of the second vibration member 4 becomes larger than the product of the static friction coefficient po and the magnitude g of the gravitational acceleration (e.g., the end time of the period T1 and the end time of the period T3 in FIG. 12) can be matched. Therefore, when the substance 40 starts to move on the upper principal surface S4U of the second vibration member 4, the velocity v40 of the substance 40 becomes the initial velocity in the same direction every time. This allows the substance 40 to continue moving in the same direction intermittently. As a result, according to the vibration structure 20, the substance 40 can be stably conveyed in the same direction by using the vibration structure 20 as a member of the conveyance device 30.

According to the vibration structure 20, the first vibration member 3 and the second vibration member 4 can be vibrated by deformation of the voltage expansion/contraction member 2. More specifically, the first coupling member 5 is an elastic member that couples the first vibration member 3 and the fixing member 1. As a result, the first vibration member 3 can vibrate in the left-right direction (e.g., first direction) with respect to the fixing member 1. Furthermore, the second coupling member 6 is an elastic member that couples the second vibration member 4 and the first vibration member 3. As a result, the second vibration member 4 can vibrate in the left-right direction (e.g., first direction) with respect to the first vibration member 3. Furthermore, the voltage expansion/contraction member 2 is supported by the fixing member 1. The voltage expansion/contraction member 2 is supported by the second vibration member 4. As a result, deformation of the voltage expansion/contraction member 2 vibrates the second vibration member 4. The vibration of the second vibration member 4 vibrates the first vibration member 3 via the second coupling member 6. As a result, according to the vibration structure 20, the first vibration member 3 and the second vibration member 4 are configured to vibrate by the deformation of the voltage expansion/contraction member 2.

According to the vibration structure 20, the thickness in the up-down direction can be reduced. More specifically, the fixing member 1 is provided with the first opening OP1. The first vibration member 3 is located in the first opening OP1 when viewed in the up-down direction (e.g., normal direction of the first principal surface S1), and is smaller than the first opening OP1 when viewed in the up-down direction (normal direction of the first principal surface S1). The first vibration member 3 is provided with the second opening OP2. The second vibration member 4 is located in the second opening OP2 when viewed in the up-down direction (e.g., normal direction of the first principal surface S1), and is smaller than the second opening OP2 when viewed in the up-down direction (e.g., normal direction of the first principal surface S1). Therefore, the fixing member 1, the first vibration member 3, and the second vibration member 4 can be overlapped when viewed in the left-right direction or the front-rear direction. As a result, according to the vibration structure 20, the thickness in the up-down direction can be reduced.

According to the vibration structure 20, lead may not be used. More specifically, the voltage expansion/contraction member 2 includes a piezoelectric body having a lead-free piezoelectric ceramic in an exemplary aspect. Therefore, the voltage expansion/contraction member 2 does not need to use lead. The voltage expansion/contraction member 2 is deformed in the left-right direction (e.g., first direction) by application of a voltage without using lead. As a result, according to the vibration structure 20, it is not necessary to use lead.

According to the conveyance device 30, the substance 40 can be efficiently conveyed by using the vibration structure 20 as a member of the conveyance device 30. More specifically, the conveyance device 30 includes the drive circuit 9 that applies the drive signal DS to the voltage expansion/contraction member 2. Furthermore, the drive signal DS includes the first component DS1 of the first resonance frequency f1 and the second component DS2 of the second resonance frequency f2. As a result, the deformation of the voltage expansion/contraction member 2 includes the first component DS1 of the first resonance frequency f1 and the second component DS2 of the second resonance frequency f2. Therefore, despite the voltage of the drive signal DS being low, the first vibration at the first resonance frequency f1 and the second vibration at the second resonance frequency f2 can be increased in the first vibration member 3 and the second vibration member 4.

On the other hand, despite the drive signal DS includes frequency components other than the first resonance frequency f1 and the second resonance frequency f2, the frequencies other than the first resonance frequency f1 and the second resonance frequency f2 are not the natural frequency of the first vibration or the natural frequency of the second vibration. Therefore, despite vibration of a frequency component other than the first resonance frequency f1 and the second resonance frequency f2 is applied from the voltage expansion/contraction member 2 to the first vibration member 3 and the second vibration member 4, the vibration of the frequency component other than the first resonance frequency f1 and the second resonance frequency f2 is attenuated without being amplified in the first vibration member 3 and the second vibration member 4. As a result, in the first vibration member 3 and the second vibration member 4, the influence of frequency components other than the first resonance frequency f1 and the second resonance frequency f2 can be reduced.

Furthermore, the amplitude P3 of the first component DS1 is larger than the amplitude P4 of the second component DS2. As a result, the length of the period T2 and the length of the period T4, which are periods during which the substance 40 moves, can be increased. Therefore, the moving distance of the substance 40 can be increased. As a result, according to the vibration structure 20, the substance 40 can be efficiently conveyed by using the vibration structure 20 as a member of the conveyance device 30.

### Second Exemplary Embodiment

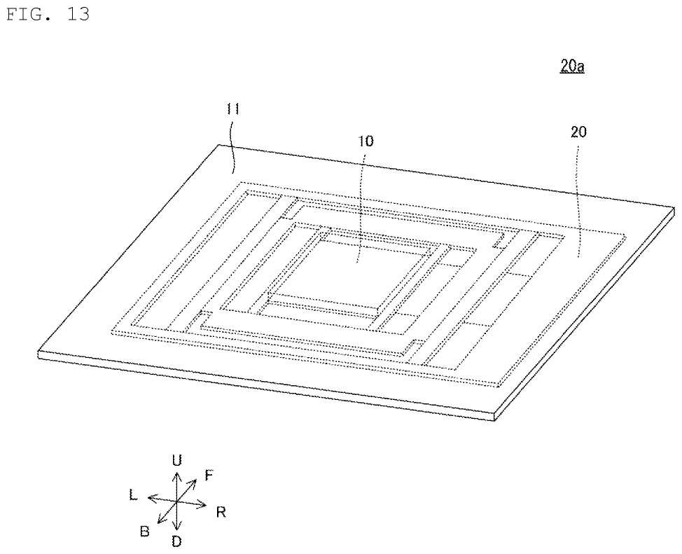

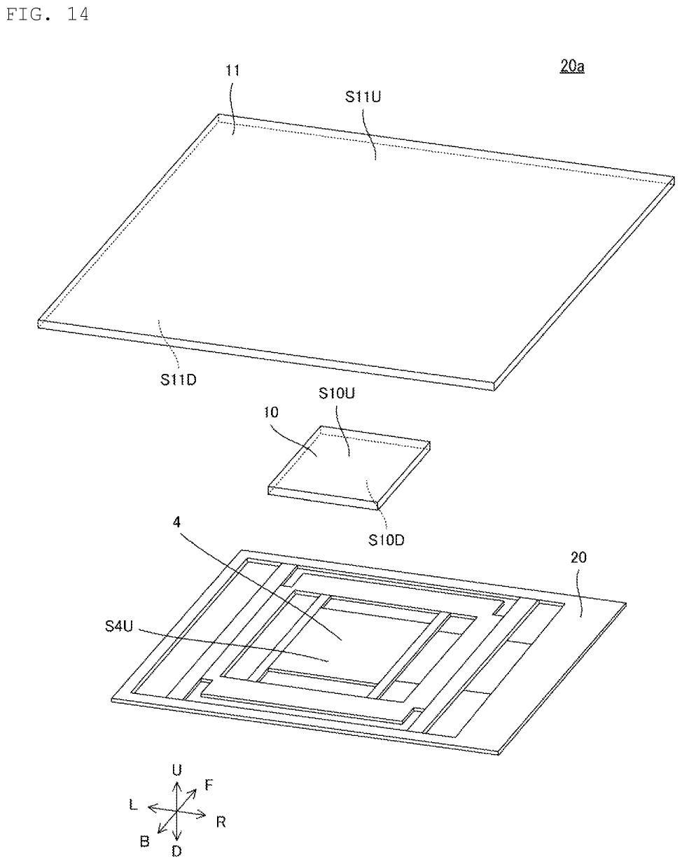

Hereinafter, a vibration structure 20a according to a second exemplary embodiment will be described with reference to the drawings. FIG. 13 is a perspective view of a vibration structure 20a according to the second embodiment. FIG. 14 is an exploded perspective view of a vibration structure 20a according to the second embodiment. It is noted that, in the vibration structure 20a according to the second embodiment, only portions different from those of the vibration structure 20 according to the first embodiment will be described, and the description thereof will be omitted.

In the present embodiment, as illustrated in FIG. 13, the vibration structure 20a further includes a spacer 10 and a panel 11. The vibration structure 20a is used as a member of the conveyance device 30 that conveys the substance 40 disposed on the upper principal surface S11U of the panel 11.

As illustrated in FIG. 14, the spacer 10 has a rectangular parallelepiped shape. Thus, the spacer 10 has a thickness in the up-down direction. Furthermore, the spacer 10 includes an upper principal surface S10U and a lower principal surface S10D. The upper principal surface S10U is located above the lower principal surface S10D.

The spacer 10 is fixed to the upper principal surface S4U of the second vibration member 4. More specifically, the lower principal surface S10D is fixed to the upper principal surface S4U of the second vibration member 4. That is, the spacer 10 is located on the upper principal surface S4U of the second vibration member 4. In the present embodiment, an area of the lower principal surface S10D of the spacer 10 viewed in the up-down direction is equal to an area of the upper principal surface S4U of the second vibration member 4 viewed in the up-down direction.

The material of the spacer 10 is, for example, metal, PET, PC, polyimide, or ABS resin. The spacer 10 fixes the panel 11 to the second vibration member 4 via, for example, an adhesive (not illustrated). It is noted that the spacer 10 may be an adhesive in an exemplary aspect.

As illustrated in FIG. 14, the panel 11 has a plate shape. Thus, panel 11 includes upper principal surface S11U and lower principal surface S11D. The upper principal surface S11U is located above the lower principal surface S11D. It is noted that, in the present embodiment, the upper principal surface S11U of the panel 11 is horizontal.

As shown, the panel 11 is fixed to the upper principal surface S10U of the spacer 10. More specifically, the lower principal surface S11D is fixed to the upper principal surface S10U of the spacer 10. That is, the panel 11 is fixed to the upper principal surface S4U of the second vibration member 4 via the spacer 10. As a result, when the second vibration member 4 vibrates in the left-right direction (e.g., first direction) with respect to the first vibration member 3, the panel 11 vibrates in the left-right direction (e.g., first direction) with respect to the first vibration member 3.

The panel 11 is located on the upper principal surface S10U of the spacer 10. Thus, panel 11 is positioned above vibration structure 20. As a result, the second vibration member 4 and the panel 11 do not come into contact with each other. More specifically, despite the second vibration member 4 and the panel 11 vibrate, the second vibration member 4 and the panel 11 do not come into contact with each other.

As illustrated in FIG. 14, the length of the panel 11 in the left-right direction (e.g., first direction) is larger than the length of the second vibration member 4 in the left-right direction (e.g., first direction) when viewed in the up-down direction (e.g., normal direction of the first principal surface S1).

The above-described vibration structure 20a also achieves the same effect as the vibration structure 20. Furthermore, according to the vibration structure 20a, by using the vibration structure 20a as a member of the conveyance device 30, a distance in which the substance 40 can be conveyed can be increased. More specifically, the vibration structure 20a includes a panel 11 fixed to the second vibration member 4. The length of the panel 11 in the left-right direction e.g., (first direction) is longer than the length of the second vibration member 4 in the left-right direction (e.g., first direction) when viewed in the up-down direction (e.g., normal direction of the first principal surface S1). Therefore, according to the vibration structure 20a, it is possible to increase the distance by which the substance 40 can be conveyed as compared with the case of conveying the substance 40 arranged on the upper principal surface S4U of the second vibration member 4 in the left-right direction. As a result, according to the vibration structure 20a, by using the vibration structure 20a as a member of the conveyance device 30, the distance in which the substance 40 can be conveyed can be increased.

### Third Exemplary Embodiment

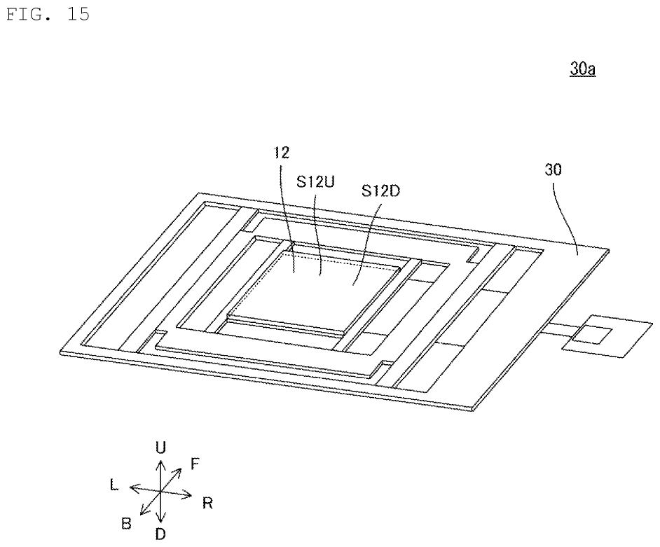

Hereinafter, a conveyance device 30a according to a third embodiment will be described with reference to the drawings. FIG. 15 is a perspective view of a conveyance device 30a according to the third embodiment. It is noted that, regarding the conveyance device 30a according to the third embodiment, only portions different from those of the conveyance device 30 according to the first embodiment will be described, and the description thereof will be omitted.

In the present embodiment, as illustrated in FIG. 15, the conveyance device 30a further includes a first contact detection sensor 12.

In the present embodiment, the first contact detection sensor 12 has a sheet shape as illustrated in FIG. 15. Thus, first contact detection sensor 12 includes upper principal surface S12U and lower principal surface S12D. The upper principal surface S12U is located above the lower principal surface S12D. It is noted that, in the present embodiment, the upper principal surface S12U of the first contact detection sensor 12 is horizontal.

The first contact detection sensor 12 is fixed to the upper principal surface S4U of the second vibration member 4. More specifically, the lower principal surface S12D is fixed to the upper principal surface S4U of the second vibration member 4. Furthermore, as illustrated in FIG. 15, the first contact detection sensor 12 covers the upper principal surface S4U of the second vibration member 4.

In operation, the first contact detection sensor 12 is configured to detect that the substance 40 applies a force to the second vibration member 4. More specifically, first contact detection sensor 12 detects contact between upper principal surface S12U of first contact detection sensor 12 and substance 40. That is, the first contact detection sensor 12 detects contact between the second vibration member 4 and the substance 40 in a pseudo manner. The first contact detection sensor 12 is, for example, a membrane type contact detection sensor, a capacitance type contact detection sensor, or a piezoelectric type contact detection sensor.

The drive circuit 9 is configured to apply a drive signal DS to the voltage expansion/contraction member 2 when the first contact detection sensor 12 detects contact between the second vibration member 4 and the substance 40. More specifically, first contact detection sensor 12 is electrically connected to drive circuit 9 via wiring (not illustrated). The first contact detection sensor 12 outputs a detection signal to the drive circuit 9 when detecting contact between the upper principal surface S12U of the first contact detection sensor 12 and the substance 40. When the detection signal is input from the first contact detection sensor 12, the drive circuit 9 applies the drive signal DS to the voltage expansion/contraction member 2.

In operation, the conveyance device 30a is configured to convey the substance 40 disposed on the upper principal surface S12U of the first contact detection sensor 12.

The conveyance device 30a as described above also has the same effect as the conveyance device 30. Furthermore, according to the conveyance device 30a, unnecessary operation of the vibration structure 20 can be suppressed. More specifically, the drive circuit 9 applies the drive signal DS to the voltage expansion/contraction member 2 when the first contact detection sensor 12 detects contact between the second vibration member 4 and the substance 40. Therefore, the drive circuit 9 does not apply the drive signal DS to the voltage expansion/contraction member 2 when the substance 40 is not in contact with the second vibration member 4. As a result, when the substance 40 is not in contact with the second vibration member 4, the voltage expansion/contraction member 2 is not deformed. Therefore, when the substance 40 is not in contact with the second vibration member 4, the first vibration member 3 and the second vibration member 4 do not vibrate. As a result, according to the conveyance device 30a, unnecessary operation of the vibration structure 20 can be suppressed.

Furthermore, according to the conveyance device 30a, power consumption can be suppressed. More specifically, the drive circuit 9 does not apply the drive signal DS to the voltage expansion/contraction member 2 when the substance 40 is not in contact with the second vibration member 4. Therefore, according to the conveyance device 30a, the power consumption of the voltage expansion/contraction member 2 and the drive circuit 9 can be suppressed. As a result, according to the conveyance device 30a, power consumption can be suppressed.

### Fourth Exemplary Embodiment

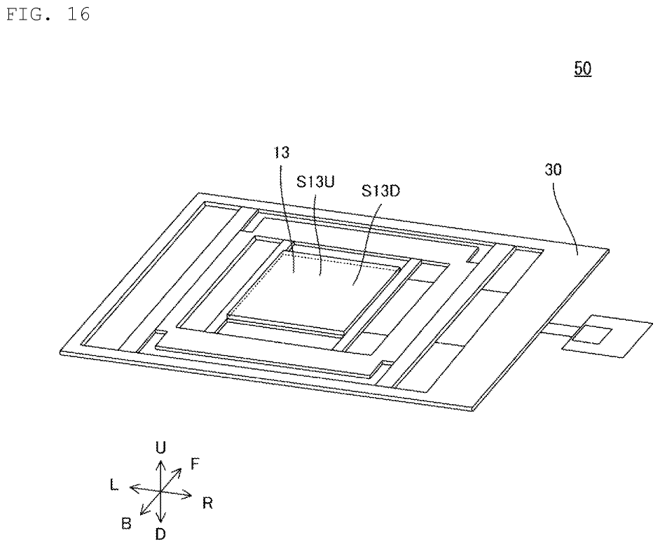

Hereinafter, a tactile sense presentation device 50 according to a fourth exemplary embodiment will be described with reference to the drawings. FIG. 16 is a perspective view of a tactile sense presentation device 50 according to a fourth embodiment. It is noted that, regarding the tactile sense presentation device 50 according to the fourth embodiment, only portions different from those of the conveyance device 30 according to the first embodiment will be described, and the description thereof will be omitted.

In the present exemplary embodiment, tactile sense presentation device 50 further includes a second contact detection sensor 13 as illustrated in FIG. 16.

In the present embodiment, the second contact detection sensor 13 has a sheet shape as illustrated in FIG. 16. Thus, second contact detection sensor 13 includes upper principal surface S13U and lower principal surface S13D. The upper principal surface S13U is located above the lower principal surface S13D.

The second contact detection sensor 13 detects that the user applies a force to the second vibration member 4. More specifically, second contact detection sensor 13 detects contact between upper principal surface S13U of second contact detection sensor 13 and the user. That is, the second contact detection sensor 13 detects contact between the second vibration member 4 and the user in a pseudo manner. It is noted that the second contact detection sensor 13 may detect the force received from the user by the upper principal surface S13U of the second contact detection sensor 13. In this case, the second contact detection sensor 13 detects the force applied to the second vibration member 4 from the user in a pseudo manner. The second contact detection sensor 13 is, for example, a membrane type contact detection sensor, a capacitance type contact detection sensor, a piezoelectric type contact detection sensor, or a strain gauge.

The drive circuit 9 is configured to apply a drive signal DS to the voltage expansion/contraction member 2 when the second contact detection sensor 13 detects contact between the second vibration member 4 and the user. More specifically, second contact detection sensor 13 is electrically connected to drive circuit 9 via wiring (not illustrated). The second contact detection sensor 13 outputs a detection signal to the drive circuit 9 when detecting contact between the upper principal surface S13U of the second contact detection sensor 13 and the substance 40. When the detection signal is input from the second contact detection sensor 13, the drive circuit 9 applies the drive signal DS to the voltage expansion/contraction member 2.

According to the tactile sense presentation device 50, unnecessary operation of the vibration structure 20 can be suppressed. More specifically, the drive circuit 9 is configured to apply the drive signal DS to the voltage expansion/contraction member 2 when the second contact detection sensor 13 detects contact (e.g., a user contact) between the second vibration member 4 and the user. Therefore, the drive circuit 9 does not apply the drive signal DS to the voltage expansion/contraction member 2 when the user is not in contact with the second vibration member 4. As a result, when the user is not in contact with the second vibration member 4, the voltage expansion/contraction member 2 is not deformed. Therefore, when the user is not in contact with the second vibration member 4, the first vibration member 3 and the second vibration member 4 do not vibrate. As a result, according to the tactile sense presentation device 50, unnecessary operation of the vibration structure 20 can be suppressed.

Furthermore, according to the tactile sense presentation device 50, power consumption can be suppressed. More specifically, the drive circuit 9 does not apply the drive signal DS to the voltage expansion/contraction member 2 when the user is not in contact with the second vibration member 4. Therefore, according to the tactile sense presentation device 50, power consumption of the voltage expansion/contraction member 2 and the drive circuit 9 can be suppressed. As a result, power consumption can be suppressed according to the tactile sense presentation device 50.

### Additional Exemplary Embodiments

It is noted that the vibration structure according to the exemplary embodiments is not limited to the vibration structures 20 and 20a, and can be changed within the scope of the gist thereof as described above. Furthermore, the configurations of the vibration structures 20 and 20a may be arbitrarily combined. Furthermore, the conveyance device according to the exemplary embodiment is not limited to the conveyance devices 30 and 30a and can be modified within the scope of the gist thereof. Furthermore, the configurations of the conveyance devices 30 and 30a may be arbitrarily combined. Furthermore, the tactile sense presentation device according to the exemplary embodiment is not limited to the tactile sense presentation device 50, and can be modified within the scope of the gist thereof.

It is noted that the voltage expansion/contraction member 2 may be supported by the first vibration member 3 in an exemplary aspect. That is, the voltage expansion/contraction member 2 may be supported by the fixing member 1 and the second vibration member 4. Also in this case, the same effect as that of the vibration structure 20 is obtained. Furthermore, the second connection member 8 may support the voltage expansion/contraction member 2 on the first vibration member 3. Also in this case, the same effect as that of the vibration structure 20 is obtained.

It is noted that the number of first coupling members 5 is not limited to two in an exemplary aspect. The number of the first coupling members 5 may be one or more. Furthermore, the first coupling member 5 may be omitted in another exemplary aspect. In this case, the first vibration member 3 may be elastically coupled to the fixing member 1.

It is noted that the number of the second coupling members 6 is not limited to two in an exemplary aspect. The number of the second coupling members 6 may be one or more. Furthermore, the second coupling member 6 may be omitted in an exemplary aspect. In this case, the second vibration member 4 may be elastically coupled to the first vibration member 3.

It is noted that the first connection member 7 may be omitted in an exemplary aspect. In this case, the voltage expansion/contraction member 2 may be supported by the fixing member 1.

It is noted that the second connection member 8 may be omitted in an exemplary aspect. In this case, the voltage expansion/contraction member 2 may be supported by the first vibration member 3 or the second vibration member 4.

It is noted that the fixing member 1 may not include the first principal surface S1 and the second principal surface S2 in an exemplary aspect.

It is noted that the first principal surface S1 and the second principal surface S2 may not be parallel to each other in an exemplary aspect.

It is noted that the fixing member 1 may not be provided with the first opening OP1 in an exemplary aspect.

It is noted that the voltage expansion/contraction member 2 may not have a thin plate shape in an exemplary aspect.

It is noted that the voltage expansion/contraction member 2 may include, for example, lead zirconate titanate (PZT) in an exemplary aspect. In this case, lead zirconate titanate (PZT) exhibits a large inverse piezoelectric effect. Therefore, the voltage expansion/contraction member 2 is greatly deformed in the left-right direction (e.g., first direction) when a voltage is applied to the voltage expansion/contraction member 2. As a result, the voltage expansion/contraction member 2 is deformed in the left-right direction (e.g., first direction) by a lower applied voltage, and the first vibration member 3 and the second vibration member 4 can be vibrated.

It is noted that the voltage expansion/contraction member 2 may be, for example, a film containing polyvinylidene fluoride (PVDF) in an exemplary aspect. In this case, the voltage expansion/contraction member 2 has a piezoelectric constant of d31. Furthermore, PVDF has water resistance. As a result, no matter what humidity environment the vibration structure 20 is in, the voltage expansion/contraction member 2 is deformed in the left-right direction (e.g., first direction) by application of a voltage to the voltage expansion/contraction member 2, and can vibrate the first vibration member 3 and the second vibration member 4.

It is noted that the voltage expansion/contraction member 2 may contain a piezoelectric fiber, an electrostrictive polymer, or a shape memory alloy in an exemplary aspect. The piezoelectric fiber is, for example, polystyrene. The electrostrictive polymer is, for example, polyurethane. Furthermore, the shape memory alloy is an energization type shape memory alloy, for example, a NiTiCu shape memory alloy. Furthermore, the voltage expansion/contraction member 2 may contain a magnetostrictive material that expands and contracts when a voltage is applied to the voltage expansion/contraction member 2. The voltage expansion/contraction member 2 may be, for example, a composite material having a structure in which a magnetostrictive material is sandwiched between piezoelectric bodies.

It is noted that the number of voltage expansion/contraction members 2 is not limited to one in exemplary aspect. A plurality of voltage expansion/contraction members 2 may be provided. In this case, the plurality of voltage expansion/contraction members 2 may be stacked on each other. Furthermore, each of the plurality of voltage expansion/contraction members 2 may be expanded and contracted.

It is noted that the first vibration member 3 may not be provided with the second opening OP2 in an exemplary aspect.

It is noted that the fixing member 1, the first vibration member 3, and the second vibration member 4 may be a single plate-shaped member in an exemplary aspect. More specifically, the fixing member 1, the first vibration member 3, and the second vibration member 4 may be manufactured by punching one plate-shaped member in an exemplary aspect. In this case, since the dimensional accuracy of the fixing member 1, the first vibration member 3, and the second vibration member 4 can be enhanced, it is possible to reduce variations in vibration of the first vibration member 3 and the second vibration member 4.

It is noted that the fixing member 1, the first vibration member 3, the second vibration member 4, the first coupling member 5, and the second coupling member 6 may be a single plate-shaped member in an exemplary aspect. More specifically, the fixing member 1, the first vibration member 3, the second vibration member 4, the first coupling member 5, and the second coupling member 6 may be manufactured by punching one plate-shaped member. In this case, since the dimensional accuracy of the fixing member 1, the first vibration member 3, the second vibration member 4, the first coupling member 5, and the second coupling member 6 can be enhanced, the variation in vibration of the first vibration member 3 and the second vibration member 4 can be further reduced.

It is noted that the fixing member 1, the first vibration member 3, the second vibration member 4, the first coupling member 5, and the second coupling member 6 may be made of different materials in exemplary aspects. In this case, the vibration of the first vibration member 3 and the second vibration member 4 can be adjusted. Furthermore, for example, by using a material having a high elastic coefficient such as rubber for the first coupling member 5 or the second coupling member 6, the first vibration member 3 and the second vibration member 4 can be vibrated despite an applied voltage being low.

It is noted that the drive signal DS is not limited to only the AC signal in an exemplary aspect. The drive signal DS may include at least an AC signal.

It is noted that the drive signal DS is not limited to the combination of the first component DS1 of the first resonance frequency f1 and the second component DS2 of the second resonance frequency f2 in an exemplary aspect. The drive signal DS may include at least both the first component DS1 of the first resonance frequency f1 and the second component DS2 of the second resonance frequency f2. Also in this case, in the first vibration member 3 and the second vibration member 4, the first vibration at the first resonance frequency f1 and the second vibration at the second resonance frequency f2 can be increased. On the other hand, in the first vibration member 3 and the second vibration member 4, vibrations of frequency components other than the first resonance frequency f1 and the second resonance frequency f2 are attenuated without being amplified. That is, in the first vibration member 3 and the second vibration member 4, the influence of frequency components other than the first resonance frequency f1 and the second resonance frequency f2 can be reduced. Therefore, the same effect as that of the conveyance device 30 is obtained.

It is noted that the conveyance device 30 may be used to convey the substance 40 disposed on the first vibration member 3 in an exemplary aspect. Also in this case, the same effect as that of the conveyance device 30 is obtained.

It is noted that the substance 40 is not limited to a small component in an exemplary aspect. The substance 40 may be dust. In this case, the conveyance device 30 can remove dust on the upper principal surface S4U of the second vibration member 4.

Furthermore, the substance 40 may be a water droplet in an exemplary aspect. That is, the substance 40 may not have a formability. In this case, the conveyance device 30 can remove water droplets on the upper principal surface S4U of the second vibration member 4.

It is noted that the upper principal surface S4U of the second vibration member 4 may not be horizontal in an exemplary aspect.

It is noted that the spacer 10 may not have a rectangular parallelepiped shape in an exemplary aspect. The spacer 10 may have a thickness in the up-down direction.

It is noted that the area of the lower principal surface S10D of the spacer 10 as viewed in the up-down direction may be smaller than the area of the upper principal surface S4U of the second vibration member 4 as viewed in the up-down direction in an exemplary aspect.

It is noted that the panel 11 may not have a plate shape in an exemplary aspect.

It is noted that the panel 11 may not be positioned above the vibration structure 20 in an exemplary aspect.

It is noted that the panel 11 may be fixed to the first vibration member 3 in an exemplary aspect. In this case, the spacer 10 is fixed to the first vibration member 3. Furthermore, the length of the panel 11 in the left-right direction (e.g., first direction) may be longer than the length of the first vibration member 3 in the left-right direction (e.g., first direction). In this case, the distance over which the substance 40 can be conveyed can be made longer than when the substance 40 arranged on the first vibration member 3 is conveyed in the left-right direction.

It is noted that the upper principal surface S11U of panel 11 may not be horizontal in an exemplary aspect.

It is noted that the upper principal surface S12U of the first contact detection sensor 12 may not be horizontal in an exemplary aspect.

It is noted that when the second contact detection sensor 13 detects the force received from the user by upper principal surface S13U of the second contact detection sensor 13, the detection signal is not limited to the digital signal, and can be a signal based on the force received from the user by upper principal surface S13U of the second contact detection sensor 13. In this case, when the detection signal is input from the second contact detection sensor 13, the drive circuit 9 can be configured to apply, to the voltage expansion/contraction member 2, the drive signal DS based on the force received from the user by the upper principal surface S13U of the second contact detection sensor 13. For example, the drive circuit 9 may increase or decrease the amplitude P3 of the first component DS1 and the amplitude P4 of the second component DS2 according to the magnitude of the force received from the user by the upper principal surface S13U of the second contact detection sensor 13. As a result, the user can receive vibration according to the force applied to the upper principal surface S13U of the second contact detection sensor 13.

It is also noted that the tactile sense presentation device 50 may be used for a game controller, a vibrator, or the like according to exemplary aspects.

It is noted that, in the vibration structure 20 according to the first exemplary embodiment, the example in which the second resonance frequency f2 is twice the first resonance frequency f1 has been described, but the second resonance frequency f2 may be three times the first resonance frequency f1. That is, the second resonance frequency f2 may be an odd multiple of the first resonance frequency f1. Also in this case, according to the vibration structure 20, new vibration can be generated.

It is noted that, in the conveyance device 30 according to the first exemplary embodiment, an example in which each of the initial phase of the first component DS1 and the initial phase of the second component DS2 is 0 has been described, but each of the initial phase of the first component DS1 and the initial phase of the second component DS2 may not be 0. For example, when each of the initial phase of the first component DS1 and the initial phase of the second component DS2 is 180 degrees, the substance 40 can continue to move in the right direction intermittently with respect to the second vibration member 4. As a result, the substance 40 can be conveyed rightward. Therefore, also in this case, the same effect as that of the convey ance device 30 is obtained.

It is noted that, in the conveyance device 30 according to the first exemplary embodiment, an example in which each of the initial phase of the first component DS1 and the initial phase of the second component DS2 is 0 has been described, but there may be a phase difference between the initial phase of the first component DS1 and the initial phase of the second component DS2. Also in this case, the same effect as that of the conveyance device 30 is obtained.

It is noted that, in the conveyance device 30 according to the first exemplary embodiment, the example in which the amplitude P3 of the first component DS1 is larger than the amplitude P4 of the second component DS2 has been described. However, the amplitude P4 of the second component DS2 may be larger than or equal to the amplitude P3 of the first component DS1. Also in this case, the same effect as that of the conveyance device 30 is obtained.

It is noted that the first contact detection sensor 12 can be configured to directly detect contact between the second vibration member 4 and the substance 40. Furthermore, the second contact detection sensor 13 can be configured to directly detect contact between the second vibration member 4 and the user.

It is noted that the first contact detection sensor 12 can be configured to detect contact between the first vibration member 3 and the substance 40. Also in this case, the same effect as that of the conveyance device 30a is obtained.

It is noted that the second contact detection sensor 13 can be configured to detect contact between the second vibration member 4 and the user. Even in this case, the same effect as that of the tactile sense presentation device 50 is obtained.

It is noted that the first contact detection sensor 12 can be configured to detect contact between the panel 11 and the substance 40. Also in this case, the same effect as that of the conveyance device 30a is obtained.

It is noted that second contact detection sensor 13 can be configured to detect contact between the panel 11 and the user. Even in this case, the same effect as that of the tactile sense presentation device 50 is obtained.

Hereinafter, a method for verifying whether or not the vibration of the first vibration member 3 or the vibration of the second vibration member 4 is superposition of the first vibration at the first resonance frequency f1 and the second vibration at the second resonance frequency f2 in the vibration structures 20 and 20a will be described.

In the proving, first, a voltage of a single frequency is applied to the voltage expansion/contraction member 2. At this time, a displacement x1 of the first vibration member 3, a velocity vl of the first vibration member 3, an acceleration al of the first vibration member 3, a displacement x2 of the second vibration member 4, a velocity v2 of the second vibration member 4, and an acceleration a2 of the second vibration member 4 are measured.

Next, the frequency of the voltage applied to the voltage expansion/contraction member 2 is changed. At this time, a displacement x1 of the first vibration member 3, a velocity vl of the first vibration member 3, an acceleration al of the first vibration member 3, a displacement x2 of the second vibration member 4, a velocity v2 of the second vibration member 4, and an acceleration a2 of the second vibration member 4 are measured.

The change of the frequency of the applied voltage and the measurement are repeated. As a result, when a resonance between the second vibration member 4 and the voltage expansion/contraction member 2 or a resonance between the first vibration member 3 and the voltage expansion/contraction member 2 is confirmed at two frequencies, it can be considered that vibration of the first vibration member 3 or vibration of the second vibration member 4 is superposition of the first vibration at the first resonance frequency f1 and the second vibration at the second resonance frequency f2 in the vibration structures 20 and 20a.

### DESCRIPTION OF REFERENCE SYMBOLS

1: Fixing member

2: Voltage expansion/contraction member

3: First vibration member

4: Second vibration member

5, 5L, 5R: First coupling member

6, 6L, 6R: Second coupling member

7: First connection member

8: Second connection member

9: Drive circuit

10: Spacer

11: Panel

12: First contact detection sensor

13: Second contact detection sensor

20, 20a: Vibration structure

30, 30a: Conveyance device

40: Substance

50: Tactile sense presentation device

DS: Drive signal

DS1: First component

DS2: Second component

Fa, Fb, Fc, Fd, Fe: Force

L1, L2: Moving distance

OP1: First opening

OP2: Second opening

P1: Maximum value

P2: Minimum value

P3, P4: Amplitude

S1: First principal surface

S2: Second principal surface

S3: Third principal surface

S4: Fourth principal surface

S10D, S11D, S12D, S13D: Lower principal surface

S4U, S10U, S11U, S12U, S13U: Upper principal surface

T: Cycle

a1, a2: Acceleration

a40: Acceleration

f: Frequency

f1: First resonance frequency

f2: Second resonance frequency

k1: First elastic coefficient

k2: Second elastic coefficient

m1: First mass

m2: Second mass

v0, v1, v2, v10, v40: Velocity

x1, x2: Displacement

μ: Dynamic friction coefficient

μo: Static friction coefficient

1. A vibration structure comprising:
a fixing member;
a voltage expansion/contraction member configured to be deformed in a first direction by a voltage;
a first vibration member that is elastically coupled to the fixing member and configured to vibrate in the first direction with respect to the fixing member; and
a second vibration member that is elastically coupled to the first vibration member and configured to vibrate in the first direction with respect to the first vibration member,
wherein the voltage expansion/contraction member is supported by the fixing member and at least one of the first vibration member and the second vibration member,
wherein a vibration of the first vibration member is superposition of a first vibration at a first resonance frequency and a second vibration at a second resonance frequency, and a vibration of the second vibration member is superposition of the first vibration and the second vibration, and
wherein the second resonance frequency is an integral multiple of the first resonance frequency.

2. The vibration structure according to claim 1, wherein the second resonance frequency is an even multiple of the first resonance frequency.

3. The vibration structure according to claim 1, further comprising one or more first coupling members that are elastic members coupling the first vibration member to the fixing member.

4. The vibration structure according to claim 3, further comprising one or more second coupling members that are elastic members coupling the second vibration member to the first vibration member.

5. The vibration structure according to claim 1, wherein the fixing member includes a principal surface and a first opening.

6. The vibration structure according to claim 5, wherein the first vibration member is disposed in the first opening in a normal direction of the principal surface.

7. The vibration structure according to claim 6, wherein the first vibration member is smaller than the first opening relative to the normal direction of the principal surface.

8. The vibration structure according to claim 6, wherein the first vibration member comprises a second opening, and the second vibration member is disposed in the second opening in the normal direction of the principal surface.

9. The vibration structure according to claim 8, wherein the second vibration member is smaller than the second opening relative to the normal direction of the principal surface.

10. The vibration structure according to claim 1, wherein the fixing member, the first vibration member, and the second vibration member are a single plate-shaped member.

11. The vibration structure according to claim 1, further comprising a panel fixed to at least one of the first vibration member and the second vibration member.

12. The vibration structure according to claim 11, wherein the fixing member includes a principal surface, and a length of the panel in the first direction is larger than a length of the first vibration member in the first direction or a length of the second vibration member in the first direction in the normal direction of the principal surface.

13. The vibration structure according to claim 1, wherein the voltage expansion/contraction member includes a piezoelectric body having a lead-free piezoelectric ceramic.

14. A vibration structure comprising:
a fixing member;
a voltage expansion/contraction member configured to be deformed in a first direction by a voltage;
a first vibration member that is elastically coupled to the fixing member and configured to vibrate in the first direction; and
a second vibration member that is elastically coupled to the first vibration member and configured to vibrate in the first direction,
wherein the voltage expansion/contraction member is supported by the fixing member and at least one of the first vibration member and the second vibration member,
wherein the fixing member includes a first opening with the first vibration member disposed therein, and
wherein the first vibration member comprises a second opening with the second vibration member disposed therein.

15. The vibration structure according to claim 14, wherein a vibration of the first vibration member is superposition of a first vibration at a first resonance frequency and a second vibration at a second resonance frequency, and a vibration of the second vibration member is superposition of the first vibration and the second vibration, and the second resonance frequency is an integral multiple of the first resonance frequency.

16. The vibration structure according to claim 14, wherein the fixing member, the first vibration member, and the second vibration member are a single plate-shaped member.

17. The vibration structure according to claim 14, further comprising:
a panel fixed to at least one of the first vibration member and the second vibration member,
wherein the fixing member includes a principal surface, and a length of the panel in the first direction is larger than a length of the first vibration member in the first direction or a length of the second vibration member in the first direction.

18. A conveyance device comprising:
the vibration structure according to claim 1; and
a drive circuit configured to apply a drive signal to the voltage expansion/contraction member,
wherein the drive signal includes a first component of the first resonance frequency and a second component of the second resonance frequency, and
wherein an amplitude of the first component is larger than an amplitude of the second component.

19. The conveyance device according to claim 18, further comprising:
a first contact detection sensor configured to detect at least one of a first contact between the first vibration member and a substance or a second contact between the second vibration member and the substance,
wherein the drive circuit is configured to apply the drive signal to the voltage expansion/contraction member when the first contact detection sensor detects at least one of the first contact and the second contact.

20. A tactile sense presentation device comprising:
the conveyance device according to claim 19; and
a second contact detection sensor configured to detect a user contact between a user and at least one of the first vibration member and the second vibration member,
wherein the drive circuit is configured to apply the drive signal to the voltage expansion/contraction member when the second contact detection sensor detects the user contact.
